(19) United States
(12) Patent Application Publication
(10) Pub. No.: US 2015/0298393 A1
(43) Pub. Date: Oct. 22, 2015

(54) 3D PRINTER SYSTEM HAVING A ROTATABLE PLATFORM, METAL FLAKE FILAMENT, MULTIPLE HEATERS, AND MODULARITY

(71) Applicant: Thomas William Suarez, Manhattan Beach, CA (US)

(72) Inventor: Thomas William Suarez, Manhattan Beach, CA (US)

(21) Appl. No.: 14/692,209

(22) Filed: Apr. 21, 2015

Related U.S. Application Data
(60) Provisional application No. 61/982,795, filed on Apr. 22, 2014.
(60) Provisional application No. 62/080,655, filed on Nov. 17, 2014.

(51) Int. Cl. B29C 67/00

(52) U.S. Cl. CPC B29C 67/0055; B33Y 30/00

(57) ABSTRACT

A three-dimensional printing system having a generally planar object platform that is rotatable about a central point is disclosed. A printing extruder nozzle is disposed above the platform and configured for radial or linear movement relative thereto while the platform rotates. The rotating platform may include an electromagnet configured to attract magnetic flakes within the material extruded by the printing nozzle. The printing nozzle may include a multi-heater having two or more heating units configured to incrementally heat the printing material from room temperature to the target extruded temperature.

### RELATED APPLICATIONS

This application claims the benefit of U.S. Provisional Application No. 61/982,795, filed on Apr. 22, 2014, and claims the benefit of U.S. Provisional Application No. 62/080,655, filed on Nov. 17, 2014.

### BACKGROUND OF THE INVENTION

The present invention relates generally to 3D printing. More specifically, this invention relates to an improved system and method for 3D printing using a rotating platform, i.e., extrusion onto a spinning, rotating, or oscillating disc, making 3D printer creation a faster and more efficient process.

Generally, 3D printing involves the use of an inkjet type print head to deliver a liquid or colloidal binder material to layers of a powdered build material. The printing technique involves applying a layer of a powdered build material to a surface. After the build material is applied to the surface, the print head delivers the liquid binder to predetermined areas of the layer of material. The binder infiltrates the material and reacts with the powder, causing the layer to solidify in the printed areas by, for example, activating an adhesive in the powder. The binder also penetrates into the underlying layers, producing interlayer bonding. After the first cross-sectional portion is formed, the previous steps are repeated, building successive cross-sectional portions until the final object is formed. See, for example, U.S. Pat. Nos. 6,375,874 and 6,416,850.

Low-cost 3D printing involves the use of a glue gun type print head to deliver heated plastic filament to a platform. The extruder heats up to a specific temperature and, with the help of a motor, plastic filament is pushed through to deposit onto the platform. The hot, extruded material also penetrates into the underlying layers, producing interlayer bonding.

An apparatus for carrying out 3D printing typically moves the print heads over the print surface in raster fashion along orthogonal X and Y axes, as well as, the Z axis for height or depth, i.e., a 3-axis system. Similar movement may be accomplished by moving the platform along X, Y and Z axes under a stationary print head. Each direction of movement requires motors to move either the platform or print head in the intended direction. One primary disadvantage of this current state-of-the-art system is that fabrication can be very slow. In addition to the time spent extruding material, each movement of the print head or platform requires time for acceleration, deceleration, and returning the print head or platform to the starting position of the next move. The inefficiencies inherent in these motions reduce the productivity of the 3D printing process.

When using a moving platform, whether in linear directions or rotational directions, there can be difficulty in getting the extruded plastic filament to adhere to the printing surface. Failure of the extruded plastic filament to adhere to the surface can result in detachment during the described movement and a failed print. 3D printing technology would be improved by the addition of a method or product with more reliable attachment and adherence to the printing surface.

In addition, current 3D printers use extruders consisting of assemblies that utilize a motor to push plastic through a heater and a nozzle. The plastic filament, typically stored at about room temperature (usually 23° C.), is heated to an extrusion temperature before it can be extruded out of the nozzle. Typical plastic filament using 3D printers usually has an extrusion temperature of about 230° C. The problem with current 3D printer extruders is that room temperature filament cannot be quickly and efficiently heated up to the desired extrusion temperature with current designs. The temperature gradient from inlet to outlet is too great for a single heating element. In addition, the room temperature filament entering the heater cools down the heating element, reducing the efficiency of the system. Such difficulties in bringing the plastic filament up to the desired extrusion temperature throttles the speed at which the plastic filament can be extruded and ultimately the 3D printers can operate.

It is, therefore, an object of the present invention to provide a system and methods for more continuously and efficiently performing 3D printing. The present invention fulfills these needs and provides other related advantages.

### SUMMARY OF THE INVENTION

The present invention is directed to a three-dimensional printing system having an object platform that is generally planar and rotatable about a central point. A printing extruder nozzle is disposed above the object platform, such that the printing extruder nozzle is movable relative to the object platform and independent of rotational movement thereof. The system may also include a printer arm extending over and generally parallel to the planar surface of the object platform, wherein the printing extruder nozzle is attached to the printer arm. The printer arm extends over the object platform from a first point adjacent to an outer edge of the object platform to a second point above the central point of the object platform. The printing extruder nozzle may be fixedly attached to a distal end of the printer arm, i.e., over the central point. The printer arm is pivotable about the first point adjacent to the outer edge of the object platform such that the printing extruder nozzle is movable radially in an arc relative to the object platform. Alternatively, the printing extruder nozzle is movable along a length of the printer arm and linearly relative to the object platform. In this alternate embodiment, the printing extruder nozzle may be fixedly attached to a carriage, which is attached to the printer arm and movable along the length of the printer arm. The printer arm may also extend to a third point adjacent to the outer edge of the object platform opposite the first point, such that the printer arm passes through the second point.

The object platform is rotatable about the central point by spinning or oscillating. The printing extruder nozzle is spaced a vertical distance above the object platform. The printing extruder nozzle and object platform are vertically adjustable relative to one another such that the vertical distance between the two is adjustable.

In an alternate embodiment, the three-dimensional printing system may comprise an object platform that is generally planar and has a receiving surface. An electromagnet is associated with the object platform and oriented so as to exert a magnetic field across the receiving surface. Again the printing extruder nozzle is disposed a vertical distance above the receiving surface. The printing extruder nozzle is configured to extrude a printing filament that has a magnetic material throughout. The magnetic field exerted by the electromagnet is configured to attract the magnetic material in the printing filament after it has been extruded by the printing extruder nozzle. This attraction by the electromagnet more reliably secures the extruding printing filament to the receiving surface during spinning or oscillation of the object platform. The electromagnet may be integrated with the object platform or disposed beneath the object platform, preferably immediately beneath. In any configuration, the electromagnet must be positioned and configured such that the magnetic field extends above the surface of the object platform sufficiently to attract the printed layer.

In yet another alternate embodiment, the three-dimensional printing system may include an object platform that is generally planar and has a receiving surface and a printing extruder nozzle disposed a vertical distance above the receiving surface. The printing extruder nozzle includes a first heater and a last heater arranged in series, which heaters are configured to incrementally heat up a printing filament from a storage temperature to an extrusion temperature. The first heater heats up the printing filament from the storage temperature to an intermediate temperature and the last heater heats up the printing filament to the extrusion temperature. The system may include one or more intervening heaters arranged in series between the first heater and the last heater. Each of the one or more intervening heaters further incrementally heats up the printing filament from the intermediate temperature.

In yet another embodiment, the three-dimensional printing system is modular having an object platform module, an extruder module, and a baseboard. The baseboard has a primary microprocessor connected to a plurality of interface ports. The object platform module has a receiving surface, a motor attached to the receiving surface, and a first microprocessor configured to receive platform commands so as to control movement of the receiving surface and motor surface. The extruder module has a printing extruder nozzle, a heater, and a second microprocessor configured to receive printer commands so as to control movement and operation of the extruder nozzle and the heater. One of the plurality of interface ports is connected to the first microprocessor and another of the plurality of interface ports is connected to the second microprocessor. The primary microprocessor is configured to generate and transmit the platform commands to the first microprocessor and the printer commands to the second microprocessor.

The object platform module may include a first verification chip connected to the first microprocessor. The first verification chip is configured to receive encrypted platform commands from the primary microprocessor, generate decrypted platform commands, and pass the decrypted platform commands to the first microprocessor. The extruder module may include a second verification chip that is connected to the second microprocessor. The second verification chip is configured to receive encrypted printer commands from the primary microprocessor, generate decrypted printer commands, and pass the decrypted printer commands to the second microprocessor. A programming device is included having a verification chip port and a programming port, the verification chip port is configured to temporarily accept the first verification chip or the second verification chip for programming.

Alternatively, the object platform module may have a unique object platform ID and the first microprocessor will only execute commands that include the unique object platform ID. Further, the extruder module may have a unique extruder ID and the second microprocessor will only execute commands that include the unique extruder ID.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawing illustrates the invention. In such drawing:

FIG. 1A is a schematic illustration of a 3D printer apparatus using a printer arm;

FIG. 1B is a schematic illustration of an alternate embodiment of a 3D printer apparatus using a printer bridge;

FIG. 2 is a schematic illustration of a plastic filament including magnetic material;

FIG. 3 is a schematic illustration of the rotating platform and electromagnet;

FIG. 4 is a schematic illustration of a multi-stage heater in a 3D printer extruder nozzle;

FIG. 5 is a schematic illustration of the modular system architecture of the inventive 3D printer system; and

FIG. 6 is a schematic illustration of the verification chip programming device.

### DETAILED DESCRIPTION OF THE PREFERRED EMBODIMENTS

The present invention is directed to a system and method for 3D printing in an improved and more efficient manner. This invention includes a spinning disc and eliminates some of the motor complexity found in the prior art. This invention vastly improves the speed of prototyping, creation, and fabrication using 3D printers.

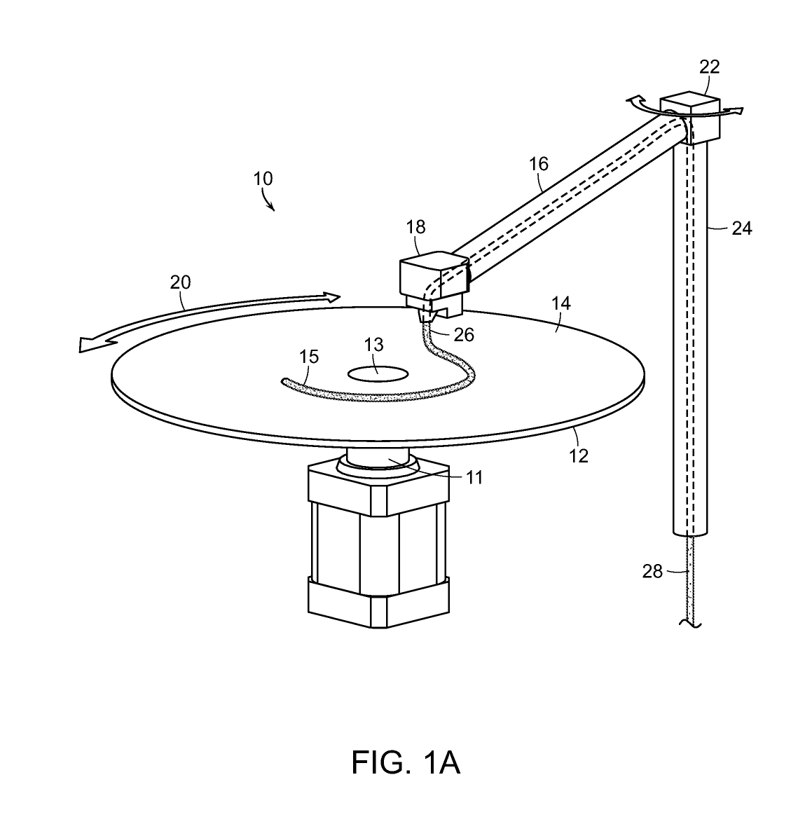

As depicted in FIG. 1A, the inventive system 10, includes a rotating platform 12 having a central point 13 and a surface 14. A radial printer arm 16 having an extruder nozzle 18 extends over the platform 12. The rotating platform 12 provides the surface 14 upon which the object 15 being printed is formed. The platform 12 is mounted upon a shaft 11 or similar support at the central point 13 that may spin, rotate, or oscillate to transfer that same motion to the platform 12.

Depending upon the shape or form of the objecting being printed, the platform 12 may be rotated in a partial turn, a full turn, or back and forth turns. Arrow 20 indicates spinning, rotational, or oscillating movement of the platform 12. One can see how these movements may simplify forming certain shapes such as curves or arcs, as opposed to angles. The platform may also be raised and lowered during the printing process to allow for printing in layers to add depth or height to the printed object.

The extruder nozzle 18 of the radial printer arm 16 is positioned over the surface 14. The radial printer arm 16 resembles the tone arm or similar structure of a record player having a stylus or needle at the end thereof. As the stylus or needle of a record player, the radial printer arm 16 suspends the extruder nozzle 18 over the surface 14 of the disc 12. Contrary to the operation of a record player, the disc 12 does not spin in only one direction at one rate and the radial printer arm 16 does not only move radially inward. In addition, the extruder nozzle may or may not contact the surface 16.

The radial printer arm 16 preferably includes a motor 22 or motors that can hold the arm 16 stationary or rotate the arm 16 about the stationary shaft 24, i.e., move the extruder nozzle 18 radially in an arc across the surface 14 between the central point 13 and an edge of the disc 12. The motor may also be disposed at the bottom of shaft 24 so at to rotate the whole shaft 24 including the arm 16 attached thereto. This radially inward or outward movement can be accomplished by rotating the arm 16 about a point or shaft 24 adjacent to the disc 12. In addition, the radial inward or outward movement may be achieved by extending or retracting the arm 16 through a fixed point or shaft 24 adjacent to the disc 12 so as to linearly move the extruder nozzle 18 between the central point 13 and an outer edge of the disc 12. The arm 16 may also be moved up or down to allow for depth or height to the printed object. Any such movement would be in response to programming created to form a 3D object.

The process of 3D printer fabrication using the inventive method involves moving the extruder nozzle 18 side-to-side or radially across the radius of the spinning disc 12 and depositing printer material 26 on the surface 14. The motor 22 is commanded by pre-programmed software, which designates the pattern required to create the current portion or layer of the 3D object to be printed. Then, with the help of another motor (not shown), the disc 12 is lowered and/or the arm 16 is raised to make room beneath the extruder nozzle 18 for the next layer. This next layer may have a different pattern, or a similar pattern, depending on the object being printed. This process is repeated in successive layers until the 3D object is finished.

The system 10 preferably includes a sphere or orb (not shown) that contains the disc 12. The sphere or orb has an opening above the disc 12 in the upper hemisphere near the pole, through which the surface 14 is accessible. The radial printer arm 16 extends over this opening to suspend the extruder nozzle 18 over the surface 14. As the material is printed in layers and the disc 12 is lowered, the created 3D object may take up as much of the interior of the sphere or orb as is necessary. Once printing is completed, the radial arm 16 is retracted and the disc 12 may be raised such that the printed 3D object is removable through the opening. The opening must be of sufficient size to accommodate printed 3D objects that may be created using the system. Alternatively, the enclosure (whether spherical or otherwise shaped) may be detached from the base so as to provide full access to the disc 12. In this way, the size of the printed 3D object is not constrained by the size of an opening. By using a detachable enclosure, printed 3D objects must simply fit inside the enclosure. Preferably, the orb enclosure is removable in sections such that the size of the 3D printed object is only constrained by the diameter of the enclosure versus the size of an opening on either the top or bottom of the enclosure.

Alternatively, FIG. 1B shows an embodiment wherein the radial arm 16 and shaft 24 are replaced by a bridge 17 that spans the disc 12 from a first point 24a adjacent to an edge of the disc 12 to a second point 24b adjacent to an opposite edge of the disc 12. The bridge 17 is preferably supported by uprights 19 that are stationary on the respective first point 24a and second point 24b. In this configuration, it is preferable that the bridge 17 pass over the central point 13 of the disc 12. The extruder nozzle 18 is movable along a length of the bridge 17 so as to linearly cover the surface 14 of the disc 12 from edge-to-edge. Preferably, the extruder nozzle 18 is mounted on a carriage 21 or similar structure that is movable along the length of the bridge 17 by any of the means commonly known in the art, i.e., gears, belts, etc.

In a further alternate embodiment, the bridge 17 may span only from the first point 24a to a point above the central point 13. As the extruder nozzle 18 moves between the first point 24a and the central point 13, it covers that particular radius of the disc 12. Rotation of the disc 12, as discussed elsewhere, ensures that the extruder nozzle 18 is capable of covering the entire surface 14 of the disc 12 although only moved linearly along this radius between the central point 13 and the first point 24a.

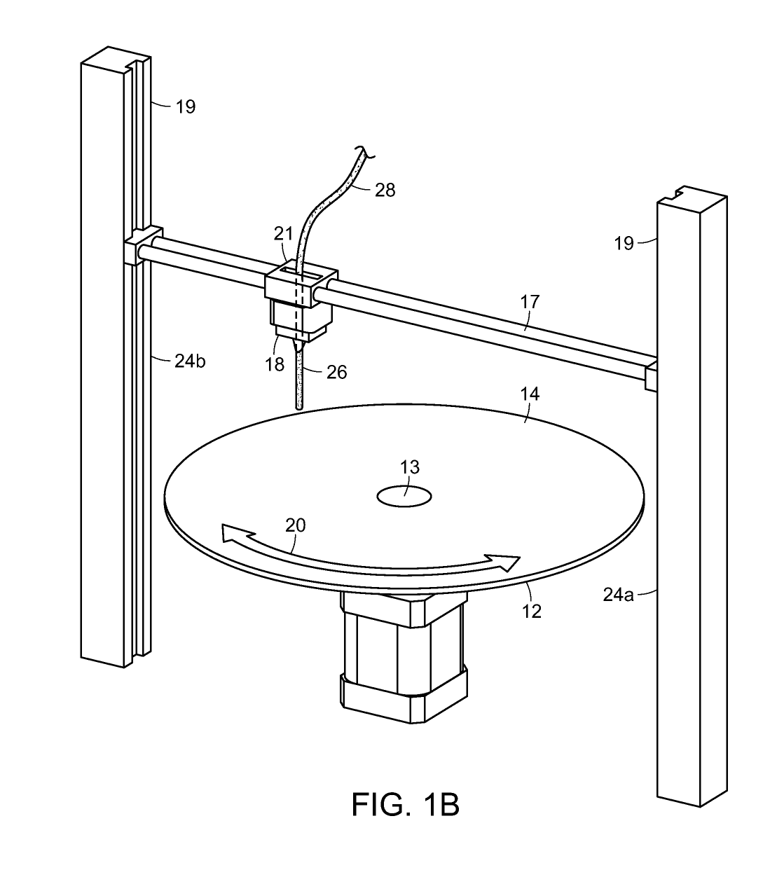

As discussed above, one difficulty with 3D printer technologies and moving platforms is ensuring that the extruded plastic filament adheres to the printing surface and does not detach during the printing process. One solution to this problem is to manufacture a plastic filament 28 as shown in FIG. 2 that includes quantities of a magnetic material 30, i.e., flakes or balls, throughout. FIG. 2 illustrates the plastic filament 28 with a close-up exploded view of the same showing the magnetic material 30. This magnetic material 30 is preferably dispersed uniformly throughout the plastic filament 28 so as to provide magnetic properties uniformly throughout the material. The magnetic material 30 is preferably comprised of materials that exhibit magnetism, i.e., produce a magnetic field in response to an applied magnetic field. Preferable materials are ferromagnetic and ferrimagnetic. One may also use paramagnetic substances provided with a strong enough electromagnet in the platform as described below. Ferromagnetic materials commonly include iron, nickel, cobalt, and their alloys, as well as some alloys of rare earth metals. Substances exhibiting ferrimagnetism include magnetite and ferrites or ceramic compounds composed of iron oxide chemically combined with one or more additional metallic elements. Another example includes hematite and other metal oxides.

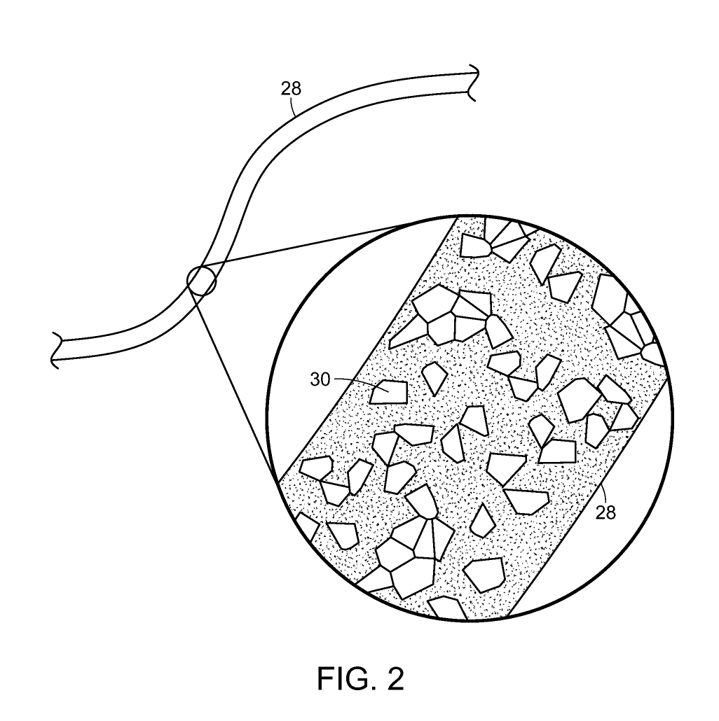

FIG. 3 illustrates a configuration of the electromagnetic disc. The disc 12 is preferably associated with an electromagnet 32 configured to exert a magnetic field across the surface 14 so as to attract the magnetic material 30. The electromagnet 32 may be disposed immediately beneath the disc 12 as shown or integrated within the disc 12. It is this magnetic attraction of the magnetic material 30 that causes the extruded plastic filament 28 to more reliably and securely adhere to the surface 14 of the rotating disc 12. The electromagnet 32 preferably has sufficient strength to create a magnetic field across the surface 14 sufficient to hold the magnetic material 30 close to the surface 14 without movement. One must be careful that the magnetic attraction is not too strong so as to avoid pulling down or compressing upper layers of printed material or otherwise deflecting printed material before it is deposited.

As an alternative to the plastic filament 28 containing magnetic material 30, the extruder nozzle 18 may be configured to print discrete balls, i.e., orbs or spheres, of similar material as the plastic filament 28. These spheres of plastic material may also contain magnetic material 30 as the plastic filament 28 described above in connection with FIG. 2. These spheres of plastic material may soften and form the object to be printed similar to the plastic filament 28 described above. The magnetic field generated by the electromagnet 32 may similarly attract the magnetic material 30 within the spheres so as to help secure the same to the surface 14 of the disc 12.

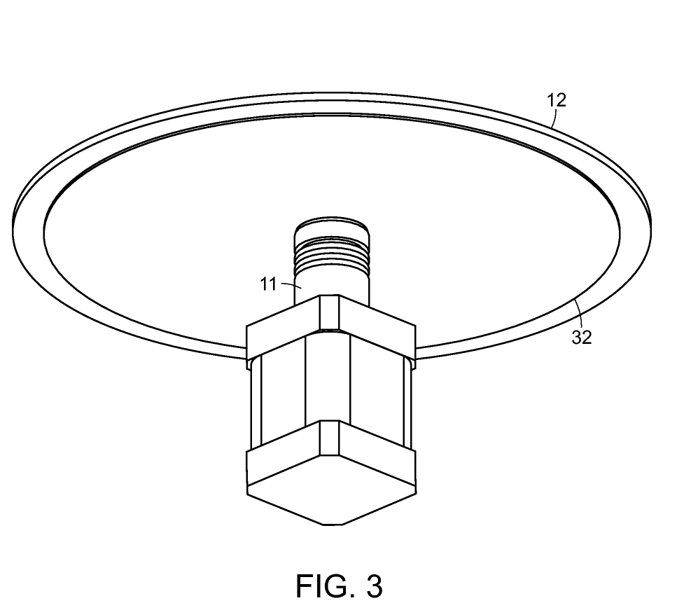

FIG. 4 illustrates an improvement on an extruder nozzle 18. An extruder nozzle typically contains a single heater to bring the temperature of the plastic filament 28 from room temperature to the desired extrusion temperature. This difference in temperature is typically about 210° C. or more. That temperature difference is often too great across a single heater to reliably, quickly and uniformly bring the plastic filament 28 up to the desired extrusion temperature. The inventive system includes multiple heaters to heat up the plastic filament in stages to the desired extrusion temperature. FIG. 3 shows a first heater 34, a second heater 36 and a third heater 38, each of which contains a heating element 40. The first heater 34 and heater element 40 is configured to bring the room temperature plastic filament 28 part of the way, i.e., a first stage, to the desired extrusion temperature. The second heater 36 and heating element 40 further heat the plastic filament 28 closer, i.e., a second stage, to the desired extrusion temperature. The third heater 38 and heating element 40 heats the plastic filament 28 the rest of the way, i.e., a third stage, to the final extrusion temperature. A drive motor 39 advances the filament 28 through the stacked heaters 34, 36, and 38.

The use of multiple heaters 34, 36, and 38 allows for incremental heating of the plastic filament so there is not such a large temperature differential from the inlet to the outlet of a single heater. With a 210° difference between room temperature and extrusion temperature, each stage of the multiple heaters 34, 36, 38 can increment the temperature by an equal amount, i.e., 70° C., or by varying amounts. For example, the first heater 34 may heat the plastic filament 28 by 100° C. or more, the second stage heater 36 may heat the plastic filament 28 by an additional 50° to 100° C., and the third stage heater 38 may heat the plastic filament 28 the remaining temperature increase to the desired extrusion temperature.

The multi-stage heater 42 may use two, three, four or more heaters to incrementally heat the plastic filament 28. The multiple stacked heaters provide intermediate steps between the cool room temperature and the hot extrusion temperature. Once heated to the desired extrusion temperature, the plastic filament 28 is extruded from the extruder nozzle 18 onto the surface 14 of the disc 12.

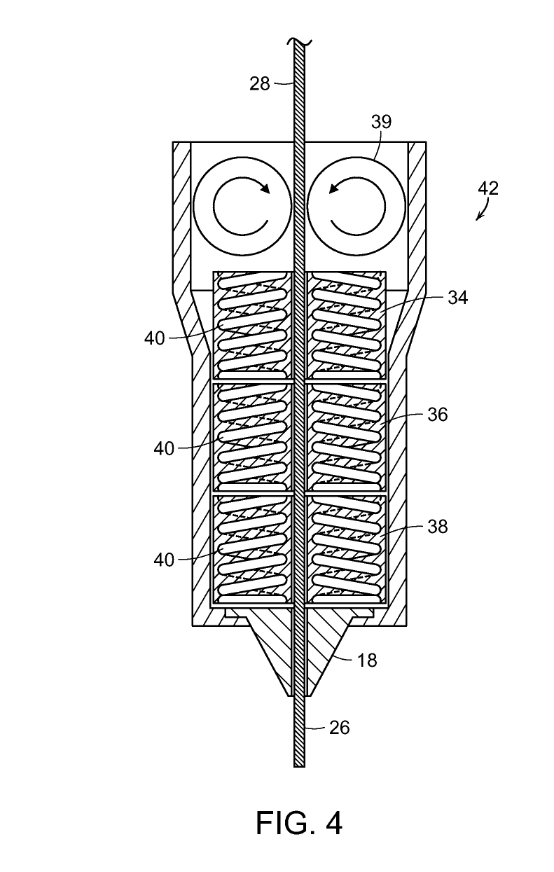

In another preferred embodiment, as illustrated in FIG. 5, the devised 3D printer system architecture uses a set of interchangeable components, or “modules”. The system originates with a base or motherboard 50. The base board 50 is a circuit board that implements one or more proprietary controller microprocessors 52, which regulate and coordinate all modules 53, while connecting with those modules through verification chips (VC) 54 (detailed below). The base board 50 also contains many proprietary ports called module interface (Ml) ports 56. These module interface ports 56 allow many different modules to be plugged in to and interface with the system. Module interface ports 56 may carry power, data, and any other connection types that are necessary for module operation. Each module preferably contains one verification chip 54, one or more module-specific microprocessors 58, and any other required module-specific parts 60, such as a motor or a multi-heater. module-specific microprocessors 58 are computer microprocessors that can independently and directly control any operation that must be done for the specific module.

A verification chip 54 is a proprietary computer microprocessor that acts as a middleman translator between the base board 50 and a module-specific microprocessor 58. Module-specific microprocessors 58 must communicate with verification chips 54 via the standard RS-232 Serial Protocol, or another standard protocol. Verification chips 54 communicate with the base board 50 via a proprietary, encrypted protocol. A Verification chip 54 must be implemented on each module. Module-specific parts 60 may be any components or parts, including but not limited to ports, capacitors, resistors, and other driver controller chips. Any protocol can be used between module-specific microprocessors 58 and module-specific parts 60, as there is no direct connection between them and the proposed system.

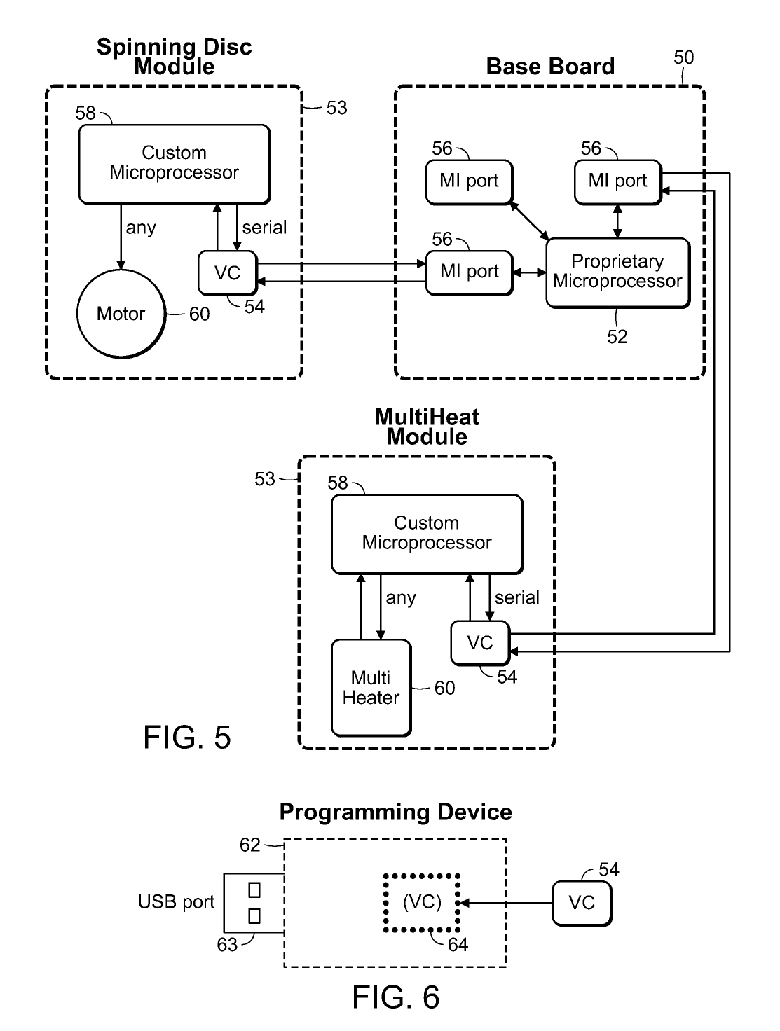

Each verification chip 54 must be programmed with a proprietary programming device 62 shown in FIG. 6. The programming device 62 requires a verification chip 54 to be “dipped” into a socket 64. The programming device 62 must be connected to a separate computer (not shown) as by a USB or similar connector 63 for programming. The programming device 62 allows the developer of the module 53 to program into the verification chip 54 which print commands the module should respond to. When each print command is issued by the base board 50, all connected verification chips 54 will first receive the command. If a verification chip 54 on a certain connected module is programmed to receive that command, it will deliver the entire command, along with all command parameters/arguments, to the module-specific microprocessor 58. Then, the module-specific microprocessor 58 operates independently to execute the command. Once the module-specific microprocessor 58 is finished with its operations, it must return a predefined finish character back to the verification chip 54 over the data line. The verification chip 54 then returns the same finish character to the base board 50, and the print operation can continue. The base board 50 will wait for the finish character before continuing a print and sending another command. The communications and execution of commands happens in fractions of a second such that the print operation appears seamless. A predefined finish character is a text character that is sent over serial data (and then over proprietary encrypted data) that signifies the end of module operation (the module operation that resulted from the received print command).

Alternatively, the verification chip 54 and encryption/decryption function thereof may be eliminated and replaced with a simple module ID number. Instead of the verification chip programmed to only respond to certain identified print commands, the module-specific microprocessor may be configured to only respond to commands that begin with a module ID number corresponding to the specific module containing the microprocessor, whether it be a spinning disc module, a multi-heat module, or another system module 53.

While described separately, the various alternate embodiments described herein may be combined to achieve benefits in a single embodiment. For example, the multiple-heater extruder may be combined with the rotating platform. The same may also be combined with the electromagnet and metal flake filament.

Although several embodiments have been described in detail for purposes of illustration, various modifications may be made without departing from the scope and spirit of the invention. Accordingly, the invention is not to be limited, except as by the appended claims.

What is claimed is:

1. A three-dimensional printing system, comprising:
an object platform that is generally planar and rotatable about a central point; and
a printing extruder nozzle disposed above the object platform, wherein the printing extruder nozzle is moveable relative to the object platform and independent of rotational movement of the object platform.

2. The three-dimensional printing system of claim 1, further comprising a printer arm extending over and generally parallel to the object platform, wherein the printing extruder nozzle is attached to the printer arm.

3. The three-dimensional printing system of claim 2, wherein the printer arm extends over the object platform from a first point adjacent to an outer edge of the object platform to a second point above the central point of the object platform.

4. The three-dimensional printing system of claim 3, wherein printing extruder nozzle is fixedly attached to a distal end of the printer arm, and the printer arm is pivotable about the first point adjacent to the outer edge of the object platform such that the printing extruder nozzle is moveable radially in an arc relative to the object platform.

5. The three-dimensional printing system of claim 3, wherein the printing extruder nozzle is moveable along a length of the printer arm and linearly relative to the object platform.

6. The three-dimensional printing system of claim 5, further comprising a carriage attached to the printer arm and moveable along the length of the printer arm, wherein the printing extruder nozzle is fixedly attached to the carriage.

7. The three-dimensional printing system of claim 3, wherein the printer arm extends to a third point adjacent to the outer edge of the object platform opposite the first point, with the printer arm passing through the second point.

8. The three-dimensional printing system of claim 1, wherein the object platform is rotatable about the central point by spinning or oscillating.

9. The three-dimensional printing system of claim 1, wherein the printing extruder nozzle is spaced a vertical distance above the object platform.

10. The three-dimensional printing system of claim 9, wherein the printing extruder nozzle and object platform are vertically adjustable relative to one another such that the vertical distance between the two is adjustable.

11. A three-dimensional printing system, comprising:
an object platform that is generally planar and has a receiving surface;
an electromagnet associated with the object platform oriented so as to exert a magnetic field across the receiving surface; and
a printing extruder nozzle disposed a vertical distance above the receiving surface.

12. The three-dimensional printing system of claim 11, further comprising printing filament having a magnetic material throughout, wherein the printing extruder nozzle is configured to extrude the printing filament having the magnetic material throughout.

13. The three-dimensional printing system of claim 12, wherein the object platform is rotatable by spinning or oscillating about a central point.

14. The three-dimensional printing system of claim 13, wherein the magnetic field exerted by the electromagnet attracts the magnetic material in the printing filament after it has been extruded by the printing extruder nozzle such that the extruded printing filament is secured to the receiving surface during spinning or oscillation of the object platform.

15. The three-dimensional printing system of claim 11, wherein the electromagnet is integrated with the object platform and configured such that the magnetic field extends immediately above the surface of the object platform.

16. A three-dimensional printing system, comprising:
an object platform that is generally planar and has a receiving surface; and
a printing extruder nozzle disposed a vertical distance above the receiving surface, wherein the printing extruder nozzle has a first heater and a last heater arranged in series and configured to incrementally heat up printing filament from a storage temperature to an extrusion temperature.

17. The three-dimensional printing system of claim 16, wherein the first heater heats up the printing filament from the storage temperature to an intermediate temperature and the last heater heats up the printing filament to the extrusion temperature.

18. The three-dimensional printing system of claim 17, further comprising one or more intervening heaters arranged in series between the first heater and the last heater, and wherein each of the one or more intervening heaters further incrementally heats up the printing filament from the intermediate temperature.

19. A modular three-dimensional printing system, comprising:
an object platform module having a receiving surface, a motor attached to the receiving surface, and a first microprocessor configured to receive platform commands so as to control the receiving surface and motor;
an extruder module having a printing extruder nozzle, a heater, and a second microprocessor configured to receive printer commands so as to control the extruder nozzle and the heater;
a base board having a primary microprocessor connected to a plurality of interface ports;
wherein one of the plurality of interface ports is connected to the first microprocessor and another of the plurality of interface ports is connected to the second microprocessor; and
wherein the primary microprocessor is configured to generate and transmit the platform commands to the first microprocessor and the printer commands to the second microprocessor.

20. The modular three-dimensional printing system of claim 19, further comprising:
a first verification chip on the object platform module, connected to the first microprocessor, and configured to receive encrypted platform commands from the primary microprocessor, generate decrypted platform commands, and pass the decrypted platform commands to the first microprocessor;
a second verification chip on the extruder module, connected to the second microprocessor, and configured to receive encrypted printer commands from the primary microprocessor, generate decrypted printer commands, and pass the decrypted printer commands to the second microprocessor; and
a programming device having a verification chip port and a programming port, wherein the verification chip port is configured to temporarily accept the first verification chip or second verification chip for programming.

21. The modular three-dimensional printing system of claim 19, wherein the object platform module has a unique object platform ID and the first microprocessor will only execute commands that include the unique object platform ID, and wherein the extruder module has a unique extruder ID and the second microprocessor will only execute commands that include the unique extruder ID.
